(19) United States
(12) Patent Application Publication
(10) Pub. No.: US 2020/0202280 A1
(43) Pub. Date: Jun. 25, 2020

(54) System and method for using natural language processing in data analytics

(71) Applicant: Level35 Pty Ltd, Maribyrnong (AU)

(72) Inventors: David Yip, Maribyrnong (AU); Greg Vandeligt, Maribyrnong (AU); James Gumley, Maribyrnong (AU)

(21) Appl. No.: 16/723,180

(22) Filed: Dec. 20, 2019

(30) Foreign Application Priority Data
Dec. 24, 2018 (AU) 2018904945

(51) Int. Cl. G06Q 10/06; G06F 40/205; G06F 40/289

(52) U.S. Cl. CPC G06Q 10/063114; G06F 40/289; G06F 40/205; G06Q 10/06393

(57) ABSTRACT

Embodiments relate generally to systems and methods for project management data analysis. A system according to some embodiments comprises: at least one processor, and memory storing program code accessible to the at least one processor to execute the program code to implement: a project data analytics module configured to retrieve project status report data, wherein the project status report data comprises natural language project status report data and quantitative project status report data; a natural language processing module configured to determine one or more project status perception identifiers and a score for each of the one or more project status perception identifiers based on the natural language project status report data; and a project data presentation module configured to communicate a visual representation of project status comprising: quantitative project status report data and the score for each of the one or more project status perception identifiers.

### RELATED APPLICATIONS

This application claims the benefit of priority from Australian patent application no. 2018904945 filed 24 Dec. 2018.

### TECHNICAL FIELD

Embodiments generally relate to methods and systems for improved project management information processing. In particular, embodiments generally relate to improved project management information processing using natural language processing based techniques.

### BACKGROUND

Modern project management systems have become highly sophisticated. This has been driven by the increasing complexity of project undertaken and managed by project management systems. Further, the increasing need for detailed information regarding status and progress of projects has driven the increasing complexity of project management systems.

One conventional approach of managing complexity in project management systems is to use a system of tagging the status of project deliverables or goals as red, amber or green. A red status is often used to indicate significant challenges in feasibility or timeliness or conformity to an allocated budget. A green status is used to indicate conformity with planned timelines, budgets and feasibility. An amber status is used to indicate potential problems or risks associated with the completion of a project deliverable or goal. Other approaches rely on tracking project status based on defined indexes, such as a schedule performance index or a cost performance index, for example.

Project managers rely on project status reporting information available to them from various teams involved in managing or delivering the project to assess whether a particular deliverable or project goal should be classified as red, amber or green. The project status reporting information may include personnel timesheet data, budget or expense data, written reports from personnel regarding status of projects, project documentation data such as a wiki, project chat or discussion thread data. A large volume of project management related data is in the form of unstructured text. Due to the large volume and inherent lack of structure, deriving actionable information from a large volume of unstructured data in the project management context is challenging for project managers.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a system for project management data analysis comprising: at least one processor, a memory storing program code accessible to the at least one processor to execute the program code to implement: a project data analytics module configured to retrieve project status report data, wherein the project status report data comprises natural language project status report data and quantitative project status report data; a natural language processing module configured to determine one or more project status perception identifiers and a score for each of the one or more project status perception identifiers based on the natural language project status report data; and a project data presentation module configured to communicate a visual representation of project status comprising: quantitative project status report data and the score for each of the one or more project status perception identifiers.

Some embodiments relate to a system for project management data analysis wherein the at least one processor executes the program code to store the quantitative project status report data, the determined one or more project status perception identifiers and the score for each of the one or more project status perception identifiers as time series data.

Some embodiments relate to a system for project management data analysis wherein the program code is further executable to implement a project insights module, wherein the project insights module is configured to perform the steps of: retrieving the time series data to determine a variation in trend between the quantitative project status report data and the score for at least one of the project status perception identifiers; allocating a numeric variation measure to the determined variation in trend; comparing the numeric variation measure with a pre-determined threshold; and if the numeric variation measure exceeds the pre-determined threshold communicate a project insight trigger.

Some embodiments relate to a system for project management data analysis wherein the project status perception identifiers are based on a sentiment analysis performed by the natural language processing module.

Some embodiments relate to a system for project management data analysis wherein the project status perception identifiers are based on a personality analysis performed by the natural language processing module.

Some embodiments relate to a for project management data analysis wherein the quantitative project status report data comprises one or more of: project red, amber or green status data; project schedule performance index data; project cost performance index data; project burn down rate data; and project story point data.

Some embodiments relate a method for project management data analysis, the method comprising: a project data analytics module retrieving project status report data, wherein the project status report data comprises natural language project status report data and quantitative project status report data; a natural language processing module determining one or more project status perception identifiers and a score for each of the one or more project status perception identifiers based on the natural language project status report data; and a project data presentation module communicating a visual representation of project status comprising: quantitative project status report data and the score for each of the one or more project status perception identifiers.

Some embodiments relate to method for project management data analysis comprising storing the quantitative project status report data, the determined one or more project status perception identifiers and the score for each of the one or more project status perception identifiers as time series data.

Some embodiments relate to a method for project management data analysis comprising a project insights module, wherein the project insights module is configured to perform the steps of: retrieving the time series data to determine a variation in trend between the quantitative project status report data and the score for at least one of the project status perception identifiers; allocating a numeric variation measure to the determined variation in trend; comparing the numeric variation measure with a pre-determined threshold; and if the numeric variation measure exceeds the pre-determined threshold communicate a project insight trigger.

Some embodiments relate to a method for project management data analysis, wherein the project status perception identifiers are based on a sentiment analysis performed by the natural language processing module.

Some embodiments relate to a method for project management data analysis, wherein the project status perception identifiers are based on a personality analysis performed by the natural language processing module.

Some embodiments relate to a method for project management data analysis wherein the quantitative project status report data comprises one or more of: project red, amber or green status data; project schedule performance index data; project cost performance index data; project burn down rate data, and project story point data.

Some embodiments relate to computer-readable storage storing executable program code for performing the method for project management data analysis.

### BRIEF DESCRIPTION OF DRAWINGS

FIG. 1 is a block diagram of a project management data analysis system;

FIG. 2 is a flowchart of a method for project management data analysis;

FIG. 3 is a flowchart for a method for project management insight generation;

FIG. 4 is an example of a graph produced by the project management system of FIG. 1;

FIG. 5 is a schematic diagram illustrating part of the method of FIGS. 2 and 3;

FIG. 6 is an entity relationship diagram illustrating part of the data generated by the methods of FIGS. 2 and 3; and

FIG. 7 is part of a screenshot of an example project management system dashboard.

### DESCRIPTION OF EMBODIMENTS

Embodiments generally relate to methods and systems for improved project management information processing. In particular, embodiments generally relate to improved project management information processing using natural language processing based techniques. Embodiments in the form of a system may be implemented as a standalone project management platform system or as an add in to existing standalone project management systems. Embodiments in the form of a method, may comprise specific computation steps of natural language analysis and derivation of actionable information or trends from a large body of natural language text.

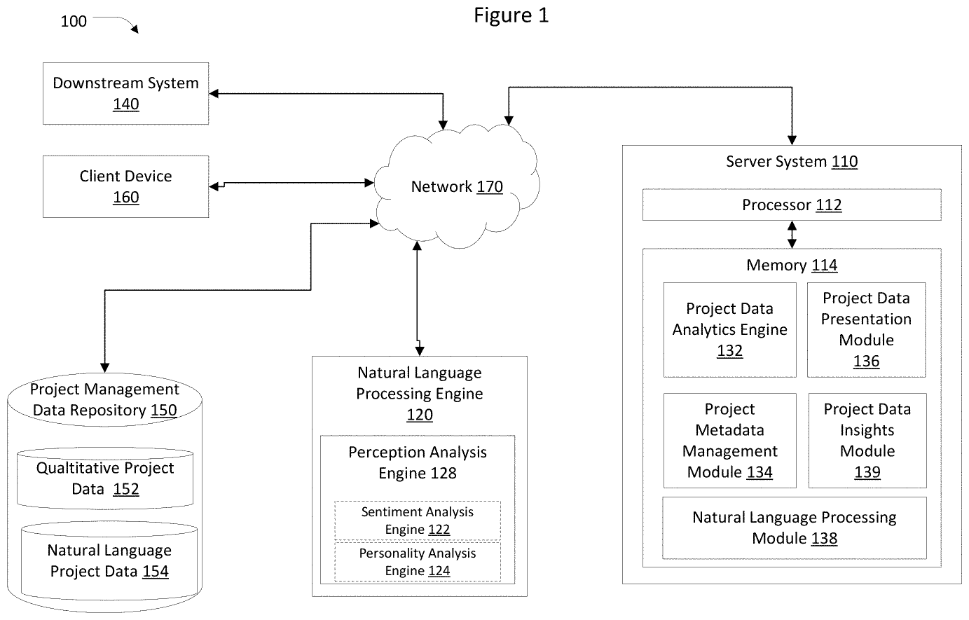

FIG. 1 is a block diagram of a system 100 for project management according to some embodiments. A server system 110 may implement the project management system or the project management system add-in module. Server system 110 comprises a processor 112 capable of executing program code held in a memory 114. Program code in memory 114 implements a project data analytics module 132, a project metadata management module 134, a natural language processing module 138 and a project data presentation module 136.

System 100 comprises a client device 160 may communicate with the project data presentation module 136 over a data communication link to receive project data, make further queries regarding project data and receive responses to the queries. The client device 160 may be a computing device such as a laptop, desktop computer, a smartphone or a tablet or any other computing device with a display.

The natural language processing module 138 communicates with a natural language processing engine 120 over a data communication link to perform natural language analysis of unstructured text. Unstructured text may include written reports regarding the health of projects, email text, text from discussion threads or chats or any other form of written communication that qualitatively or subjectively communicates the status or health of a project.

The natural language processing engine 120 may be a cloud based natural language processing service such as an IBM™ Watson Natural Language Classifier, or Microsoft™ Azure Text Analytics, or Amazon™ Comprehend. In some embodiments, the natural language processing engine 120 may be a bespoke natural language processing engine specifically trained and configured for the purpose of processing natural language text generated in the context project management reporting.

The natural language processing engine 120 may comprise a perception analysis engine 128 that is configured to process natural language text to identify a project status perception based on natural language text. In some embodiments, the perception analysis engine 128 may comprise a sentiment or emotion analysis engine 122 that assesses sentiments, emotions, tone or feelings exhibited in unstructured natural language text. The sentiments may comprise: anger, fear, joy, sadness, analytical, confident and tentative, for example. The analysis of natural language text may identify one or more sentiments exhibited in the text and a numeric value associated with a measure of the extent of each sentiment exhibited in the text.

The perception analysis engine 128 may comprise a personality analytics engine 124 that assesses the personality attributes or attributes of the author or creator of unstructured natural language text. The personality or attribute traits may include: agreeableness, conscientiousness, extraversion, emotional range, openness, for example. The analysis of natural language text may identify one or more personality traits exhibited in the text and a numeric value associated with a measure of the extent of each personality trait exhibited in the text.

The project management system 100 comprises a project management data repository 150 which is a database or repository of project related data. Specifically, the project management data repository 150 comprises qualitative project status data 152 and natural language project status data 154. Qualitative project status data 152 may comprise numeric project schedule, project cost or project resource usage related data for example. Natural language project status data 154 may comprise data in the form of free text related to the status or health of a project. This may include project status reports, description of intermediate project deliverables, project discussion thread text, project related chat text, email text regarding the status of a project.

Downstream systems 140 may comprise other systems that receive triggers or messages from the server system 110 and perform specific actions in response to a project insight identified by the server system 110. Downstream system 140 may perform the function of escalation based on a project insight, communication of the project insight or further analysis of project data based on the insight.

The project management system 100 comprises a network 170. The network 170 may include, for example, at least a portion of one or more networks having one or more nodes that transmit, receive, forward, generate, buffer, store, route, switch, process, or a combination thereof, etc. one or more messages, packets, signals, some combination thereof, or so forth. The network 108 may include, for example, one or more of: a wireless network, a wired network, an internet, an intranet, a public network, a private network, a packet-switched network, a circuit-switched network, an ad hoc network, an infrastructure network, a public-switched telephone network (PSTN), a cable network, a cellular network, a satellite network, a fiber optic network, some combination thereof, or so forth.

The network 170 enables communication between server system 110 and the natural language processing engine 120 to allow calls to a natural language processing API, for example. The network 170 also enables communication between server system 110 and the client device 160 to allow transmission of information by the project data presentation module 136 to the client device 160 and query of data by the client device 160 to the project data presentation module 136, for example. The network 170 also enables communication between server system 110 and the project management data repository 150.

One practice of project management involves the regular reporting of various attributes associated with a project by the project manager. These attributes can either be qualitative or quantitative. For example, a natural language statement such as “The project is progressing well” would be a qualitative assessment. “The project is tracking 2 weeks ahead of schedule” would be a quantitative assessment. In order to provide a quick visual indication to the reader, both qualitative and quantitative attributes are then subjectively assigned a status colour. For the above example, since both attributes are positive, they would be assigned a “Green” colour. If there are issues emerging in the project that could negatively impact its success criteria, they would be described and reported accordingly, and the description assigned an “Amber” colour to draw attention to the specific matter. If there are project attributes that fall outside of desired or acceptable requirements, then they would be described and reported accordingly, and assigned a “Red” colour as a negative indicator.

The quantitative attributes may include agile project management or scrum based project management quantitative project status reporting attributes. This may include, for example, a burn down measure or burn down rate based on a ratio of a measure of outstanding deliverables to the time remaining to complete the outstanding deliverables. The quantitative project status reporting attributes in some embodiments may also be based on a story point measure or story point data, whereby a story point is a measure of the time and complexity of one or more deliverables.

The colour coded representation of project status or reporting attributes improves the ease of comprehension of complex project status reports. However, the colour allocation of project status or reporting attributes is a subjective step wherein an individual such as a project manager assesses if the project status or reporting attribute is in a “red”, “green” or “amber” state. The assessment of which status to associate with a project status or reporting attributes may vary depending on an individual's perceptions of risk and their past experience. Therefore, although the colour coded status indicators provide an intuitive and succinct method of reporting status of a project, there is inherent risk in this oversimplification. The risk may include critical or at risk attributes being colour coded “green” or “amber” thereby delaying the necessary timely attention to an project attribute. Similarly, a low risk project attribute may be colour coded “amber” or “red” resulting in unnecessary allocation of resources to a project attribute. In some contexts, the allocation of colour coded statuses to project attributes may be biased for political reasons.

The conventional method of project status reporting is largely reliant on the subjective nature of colour assignment as health indicators by the project manager at a point in time. It is not only open to interpretation as to what constitutes “Red”, “Amber” or “Green”, and under what conditions the transitions occur, but such statuses can also be easily manipulated to avoid or emphasise particular conditions by a project manager. Furthermore, if there is a change in project manager during a reporting period, there is no way of standardising colour assignment decisions between individuals, resulting in further variances in reported data.

In addition, even if detailed project information and context is described in report text fields, this is often overlooked unless specifically highlighted by a “Red” or “Amber” colour indictor, as “Green” typically implies no attention needed. The rich details contained in text fields associated with “Green” project attributes are effectively lost or often not considered in detail.

To improve the likelihood of timely delivery of a project, it is very important to address issues as they arise, the earlier the better. However, it may be possible to avoid or delay reporting negative issues until absolutely necessary, which impacts delivery risk. Detailed manual analysis of verbal and non-verbal cues regarding the health of a project is time consuming and non-scalable as project complexity increases.

Embodiments described herein use artificial intelligence (AI) natural language processing technologies to capture the metadata of a project status report, and provide valuable additional input for advanced analytics, for example.

By leveraging certain natural language processing technologies, embodiments can analyse and assign numerical values to natural language text that describe specific attributes. For example, using a sentiment analysis engine 122, such as IBM™ Watson's “Tone Analyzer”, embodiments are able to determine the emotional sentiment of the writer of a piece of text and translate the unstructured free text data into a set of structured numerical data for further analysis. Similarly, using another language processing technology configured as a personality analysis engine 124, such as IBM™ Watson's “Personality Insights”, embodiments are able to determine the personality characteristics of the writer of a piece of text and translate the unstructured free text data into a set of structured numerical data for further analysis. Although specific language processing technologies from IBM have been mentioned, they are for example only, and the embodiments are not limited to using only these specific language processing technologies. The personality or sentiment attributes identified by processing natural language text in project report data will be collectively described as “project status perception identifiers.” The numeric scores output by engines 122 or 124 associated with the personality or sentiment attributes identified by processing natural language text in project report data will be collectively described as “project status perception identifier scores.”

With each project status report (ie. “data sample”) the project status perception identifier scores are recorded and tracked over time. A trend graph may be drawn that correlates the project status perception identifier scores against conventional project metrics such as RAG status, budget, time, etc.

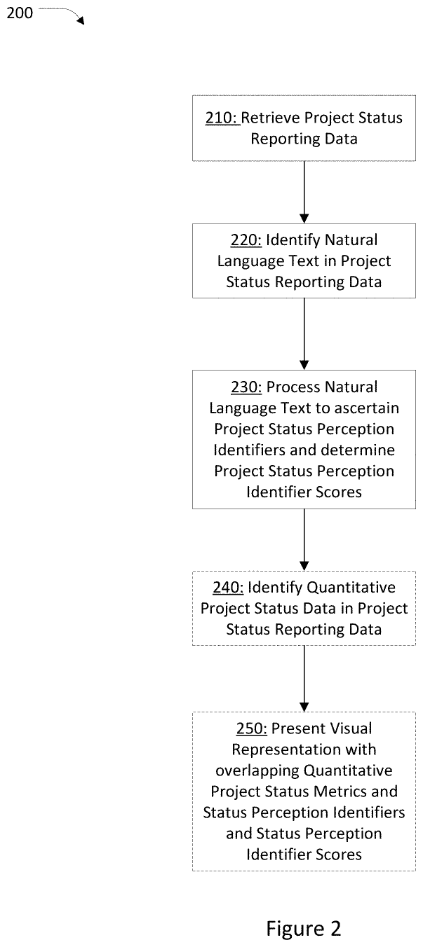

FIG. 2 is a flowchart of a method 200 comprising steps performed as part of project management data analysis performed at least in part by the project data analysis engine 132 and natural language processing module 138 of some embodiments. Step 210 comprises a retrieval of project status reporting data by the project data analysis engine 132 from the project management data repository 150. At step 220, the project data analysis engine 132 analyses the retrieved project status reporting data to identify any natural language text. If any natural language text is identified, then at step 230 the natural language processing module 138 communicates with the natural language processing engine 120 to identify project status perception identifiers and determines scores associated with each project status perception identifier. The communication between the natural language processing module 138 and the natural language processing engine 120 may be in the form of an API call and a return to an API call over a data communications network, for example.

At step 240, the project data analysis engine 132 may identify quantitative project status data in the project status reporting data received at step 210. At step 250, the project data presentation module 136 may use the data determined at steps 230 and 240 to generate code executable to present a visual representation with a combination of quantitative project status data and the scores associated with each project status perception identifier or a representation of the scores. The display may be in the form of a time series graph that shows variation in both quantitative project status data and the scores associated with each project status perception identifier over time, for example. The visual representation generated by the project data presentation module 136 may be served to a client device 160 with a display.

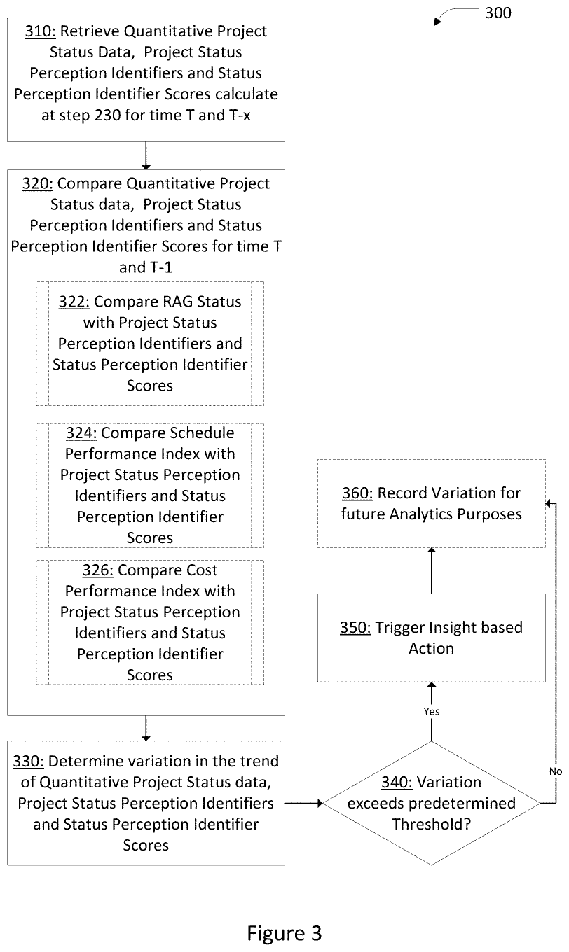

FIG. 3 is a flowchart of a method 300 comprising steps performed for insight generation by a project data insights module 139 of some embodiments. In general, the project data insights module 139 analysis the time series data determined as part of method 200 to identify any insights related to the health of the project that may not be readily apparent from quantitative project status reporting data.

At step 310, the project data insights module 139 is executed by the processor 112 to retrieve quantitative project status data, project status perception identifiers and project status perception identifier scores calculated as part of method 200. The retrieved data may be in the form of data obtained from at-least two points in a time series, for example at times T and T-x, wherein time T-x is a selected time (at which method 200 was performed and project status perception identifiers and project status perception identifiers scores were stored in memory 114 or another data repository) chronologically before time T.

At step 320, the project data insights module 139 compares the data retrieved at step 310 over the at least two points in the time series data. This comparison is based on the principle that a change in project status identifier scores should be reflected in the quantitative project status data and vice versa. The comparison may involve a comparison based on red, amber and green status values (step 322), or a comparison based on a schedule performance index (step 324) or a comparison based on a cost performance index (step 326).

At step 330, the project data insights module 139 determines variations in the trend of quantitative project status data and project status perception scores. Such variation may be, for example, the project metric continuing to stay green but a sentiment metric changing from joy to sadness or from joy to disgust or from joy to anger, for example. Any variation in the trend is quantified as a trend variation measure by the project data insight module 139 as part of the step 330. The trend variation measure is compared against one or more variation thresholds at step 340. The various thresholds may be determined according to one or more business rules depending on the nature and the sensitivity of the project.

If the trend variation measure exceeds one or more of the pre-configured variation thresholds, then the project insights module 139 may trigger an insight based action, for example a communication to downstream system 140 to take further action. At step 360, the trend variation measure may be recorded in the memory 114 for future analysis purposes.

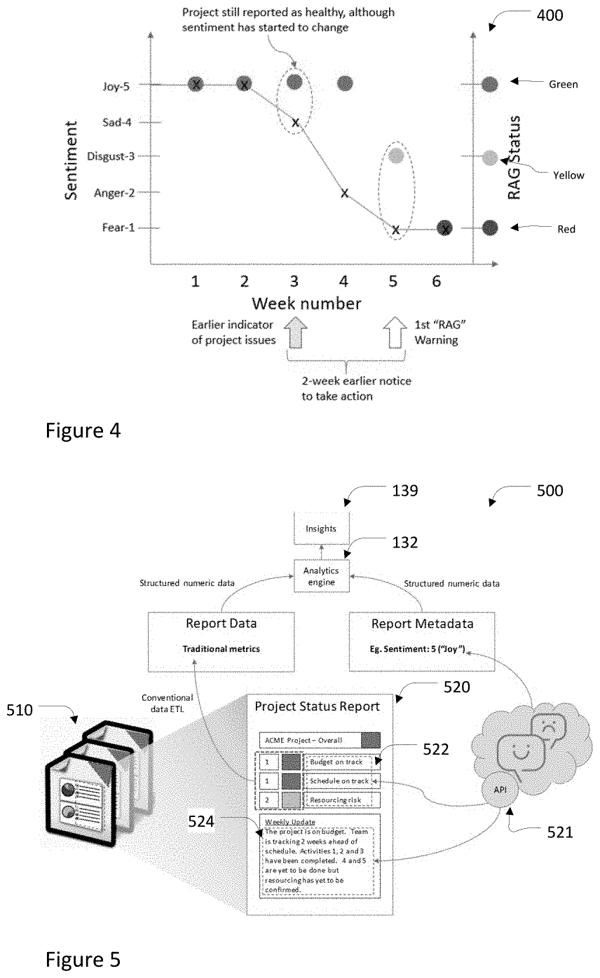

FIG. 4 is a graph 400 which illustrates overlapping sentiment and red, amber and green status metrics. The x axis of the graph 400 represents time in terms of weeks. The y axis represents both sentiment and red, amber or green status of a project or a project deliverable or a project goal. As is observable from the graph 400, at week 3, the sentiment value starts to dip from Joy-5 to Sad-4. This sentiment value may be calculated based on the analysis of natural language text as described in relation to method 200 of FIG. 2.

Although there is a noticeable shift in the sentiment value in week 3, the manually assigned red, amber and green project status value stays green over weeks 3 and 4. Only when the sentiment value substantially drops down to Fear-1, the red, amber and green project status value changes to amber. As illustrated in chart 400, the embodiments provide an early warning of unmaterialized or difficult to observe problems or risks associated with the completion of a project. The conventional red, amber and green project status values assigned by a project manager may not pick up a change in sentiment relating to a project until much later in the timeframe as more significant problems materialize. In the graph 400 as sentiment value drops down to Fear-1 in weeks 5 and 6; the red, amber and green project status value finally changes to red.

FIG. 5 is a schematic diagram 500 that illustrates aspects of some embodiments. 520 is an example of a project status report which comprises quantitative project data 522 comprising red, amber and green status values. The project status report 520 also comprises a natural language text component 524. The project status report 520 may be extracted from project status data 510 held in project management data repository 150 for example. Graphic 521 represents an API (application programming interface) call to a natural language processing engine 120 passing the natural language text component 524 as one of the parameters to receive a return in the form of one or more project status perception identifiers and scores associated with each of the project status perception identifiers. The returned information along with the quantitative project data 522 is further used by the project data insight module 139 and the project data analytics engine 132.

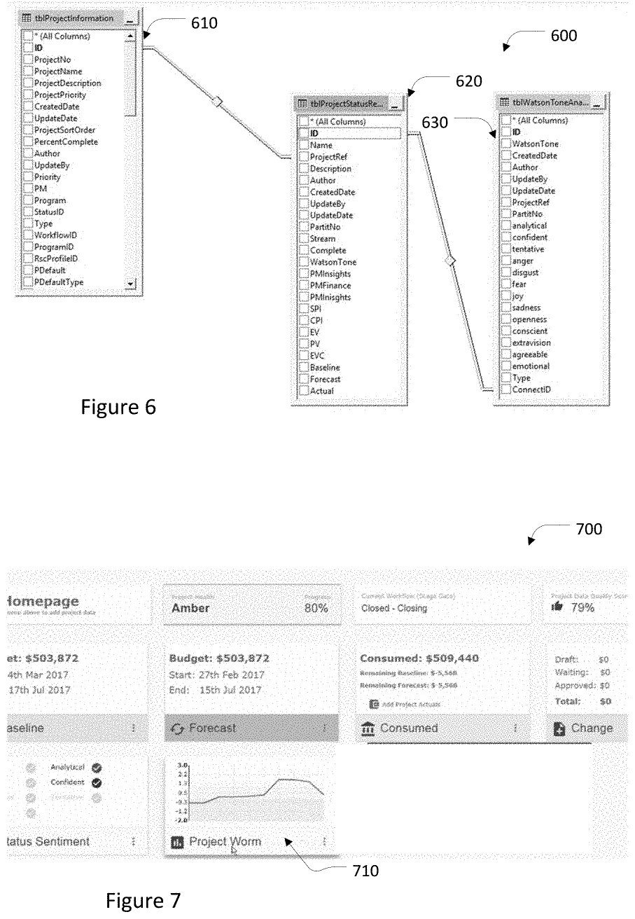

FIG. 6 is an entity relationship diagram 600 showing some of the relational tables managed by the server system 110. Table 610 stores project related information such as project identifiers, names, description and other attributes to uniquely identify and describe a project. Table 620 stores project status related data. This may be in the form of a time series data and includes qualitative aspects of the project at a particular point in time, such as the red, amber and green status, schedule performance index, cost performance index, for example. Table 630 stores project status perception identifiers and project status perception identifier scores related to each project status report. Between tables 610 and 620 there may be a one to many relationship. Between tables 620 and 630 there may be a one to many relationship.

FIG. 7 is a screenshot 700 of a project management dashboard that may be implemented by the server system 110. Screenshot 700 illustrates a project worm 710 that is in the form of a line chart that shows the project status perception identifier scores related to a particular project status perception identifier over time to provide useful trend information regarding the health of a project.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A system for project management data analysis comprising:
at least one processor,
memory storing program code accessible to the at least one processor to execute the program code to implement:
a project data analytics module configured to retrieve project status report data, wherein the project status report data comprises natural language project status report data and quantitative project status report data;
a natural language processing module configured to determine one or more project status perception identifiers and a score for each of the one or more project status perception identifiers based on the natural language project status report data; and
a project data presentation module configured to communicate a visual representation of project status comprising: quantitative project status report data and the score for each of the one or more project status perception identifiers.

2. The system of claim 1, wherein the at least one processor executes the program code to store the quantitative project status report data, the determined one or more project status perception identifiers and the score for each of the one or more project status perception identifiers as time series data.

3. The system of claim 2, wherein the program code is further executable to implement a project insights module, wherein the project insights module is configured to perform the steps of:
retrieving the time series data to determine a variation in trend between the quantitative project status report data and the score for at least one of the project status perception identifiers;
allocating a numeric variation measure to the determined variation in trend;
comparing the numeric variation measure with a pre-determined threshold; and
if the numeric variation measure exceeds the pre-determined threshold communicate a project insight trigger.

4. The system of claim 1, wherein the project status perception identifiers are based on a sentiment analysis performed by the natural language processing module.

5. The system of claim 1, wherein the project status perception identifiers are based on a personality analysis performed by the natural language processing module.

6. The system of claim 1, wherein the quantitative project status report data comprises one or more of:
project red, amber or green status data;
project schedule performance index data;
project cost performance index data,
project burn down rate data; and
project story point data.

7. A method for project management data analysis, the method comprising:
a project data analytics module retrieving project status report data, wherein the project status report data comprises natural language project status report data and quantitative project status report data;
a natural language processing module determining one or more project status perception identifiers and a score for each of the one or more project status perception identifiers based on the natural language project status report data; and
a project data presentation module communicating a visual representation of project status comprising: quantitative project status report data and the score for each of the one or more project status perception identifiers.

8. The method of claim 7, further comprising storing the quantitative project status report data, the determined one or more project status perception identifiers and the score for each of the one or more project status perception identifiers as time series data.

9. The method of claim 8, further comprising a project insights module,
wherein the project insights module is configured to perform the steps of:
retrieving the time series data to determine a variation in trend between the quantitative project status report data and the score for at least one of the project status perception identifiers;
allocating a numeric variation measure to the determined variation in trend;
comparing the numeric variation measure with a pre-determined threshold; and
if the numeric variation measure exceeds the pre-determined threshold communicate a project insight trigger.

10. The method of claim 7, wherein the project status perception identifiers are based on a sentiment analysis performed by the natural language processing module.

11. The method of claim 7, wherein the project status perception identifiers are based on a personality analysis performed by the natural language processing module.

12. The method of claim 7, wherein the quantitative project status report data comprises one or more of:
project red, amber or green status data;
project schedule performance index data;
project cost performance index data;
project burn down rate data; and
project story point data.

13. Computer-readable storage storing executable program code for performing the method of claim 7.
